(19) United States
(12) Patent Application Publication
(10) Pub. No.: US 2026/0254139 A1
(43) Pub. Date: Aug. 27, 2026

(54) ADJUSTABLE KEYED ELECTRICAL GUIDE CONNECTOR

(71) Applicant: Raytheon Company, Arlington, VA (US)

(72) Inventor: David J. Kok, Fort Wayne, IN (US)

(21) Appl. No.: 19/064,465

(22) Filed: Feb. 26, 2025

(51) Int. Cl. H01R 12/70; H01R 13/645

(52) U.S. Cl. CPC H01R 12/7005; H01R 13/6453

(57) ABSTRACT

An electrical guide connector can include a main body defining a reception opening. The reception opening can extend at least partially into the main body. A secondary body is, for example, connectable with the main body. The secondary body can include an alignment opening that is at least partially aligned with the reception opening and extends through the secondary body. A rotatable article can be positioned between the main body and the secondary body. The rotatable article can include a keyed aperture at least partially aligned with the alignment opening and the reception opening. In an example, the rotatable article is rotatable to orient the keyed aperture with respect to the main body and the second body to receive a guide pin.

### GOVERNMENT RIGHTS

This invention was made with Government support under Contract Number N00019-24-C-0047. The Government has certain rights in this invention.

### BACKGROUND

Backplane systems are components in computer systems that can include electrical connectors that can be arranged in parallel to form a computer bus that enables interconnection of multiple printed circuit boards. These systems can include, for example, connectors, slots, and sockets that allow insertion of various modules or daughter cards that can facilitate power distribution and data communication between components.

For example, VPX board systems can utilize modules that can have a specific purpose to facilitate precise connections between circuit boards and backplanes. Guide pins, for instance, on the backplane can interface with guide connectors on the modules. The guide connectors can assist in accurate blind mate connections while providing necessary ground connections.

### SUMMARY

An adjustable keyed electrical guide connector can be implemented as part of an electrical connection system, such as a high-speed electrical connection system. In an example, the electrical guide connector can interface with a backplane having interconnects and keyed guide pins. The electrical guide connector can accommodate different keyed guide pins by, for example, rotating a keyed rotatable article between two or more orientations. For example, an electrical guide connector can be compatible with at least two different guide pins on two different backplanes. The guide connector can include features for securing the rotatable article in position.

### BRIEF DESCRIPTION OF THE DRAWINGS

FIG. 1 illustrates an electrical connection system according to at least one example of the present disclosure.

FIG. 2 illustrates an example of an exploded view of an electrical guide connector according at least one example of the present disclosure.

FIG. 3 illustrates an example of a front view of an electrical guide connector according to at least one example of the present disclosure.

FIG. 4A illustrates an example of a cross section of an electrical guide connector in an engaged position according to at least one example of the present disclosure.

FIG. 4B illustrates an example of a cross section of a rear view of an electrical guide connector in an engaged configuration according to at least one example of the present disclosure.

FIG. 5A illustrates an example of a cross section of an electrical guide connector in a disengaged position according to at least one example of the present disclosure.

FIG. 5B illustrates an example of a cross section of a rear view an electrical guide connector in a disengaged position according to at least one example of the present disclosure.

### DETAILED DESCRIPTION

VPX board systems, also known as VITA 46, can include backplanes and associated cards (or modules) that can be used in high-performance computing applications. In some examples, VPX board systems can be useful in sectors that can benefit from high-speed electrical connections. These systems can be characterized by their ability to support high-speed data transfer and robust power distribution across multiple interconnected modules. Some VPX board systems include a series of connectors, slots, and sockets that facilitate the insertion of various modules or daughter cards, such as CPUs, memory modules, and input/output cards.

The architecture of VPX systems can provide enhanced modularity and scalability, enabling users to customize configurations to meet specific application requirements. In high-speed electrical systems, such as those utilizing VPX board systems, blind connections can be facilitated with engagement between guides on the modules and pins on the backplanes that ensure precise mating. The engagement can reduce the risk of misalignment and can assist in ensuring reliable electrical and mechanical connections. Blind connections can refer to the process of connecting components without direct visual guidance, often relying on mechanical features to ensure proper alignment and engagement.

In some examples, the one or more guide pins on a backplane includes a keyed profile. The keyed profiles of the one or more guide pins (hereinafter “keyed guide pins”) can be couplable with keyed apertures of the guide connectors. The engagement between the keyed guide pins and the keyed apertures can assist in ensuring selected modules can be connected with associated backplanes. For example, the keyed guide pins and the keyed apertures can assist in ensuring selected modules can only be connected with specific associated backplanes. The integration of advanced features, such as adjustable keyed guide connectors, can further enhance the adaptability and functionality of VPX board systems, can assist with precise and secure connections between components.

An adjustable keyed electrical guide connector can be designed to facilitate precise and reliable connections within electrical connection systems, such as those used in VPX board systems. The adjustable keyed electrical guide connector can provide a versatile guide module that can accommodate at least two keyed guide pins without requiring disassembly or reassembly of the components. An electrical guide connector including a keyed aperture that can accommodate different keyed guide pins can reduce the risk of foreign object damage (FOD) and can improve operational efficiency.

The adjustable keyed electrical guide connector can include a rotatable article including a keyed aperture that allows for adjustment of the keying angle. For example, an adjustable, rotatable article can enable the guide connector to interface with different keyed guide pins on a backplane. This capability can be advantageous in environments where adaptability and secure connections can be beneficial or desired. The design incorporates a split body that can retain a rotatable article. For example, a rotatable article can be a wheel that can rotate when an engagement fastener is disengaged. The rotatable article can be engaged with the engagement fastener when the rotatable article is in a preferred position.

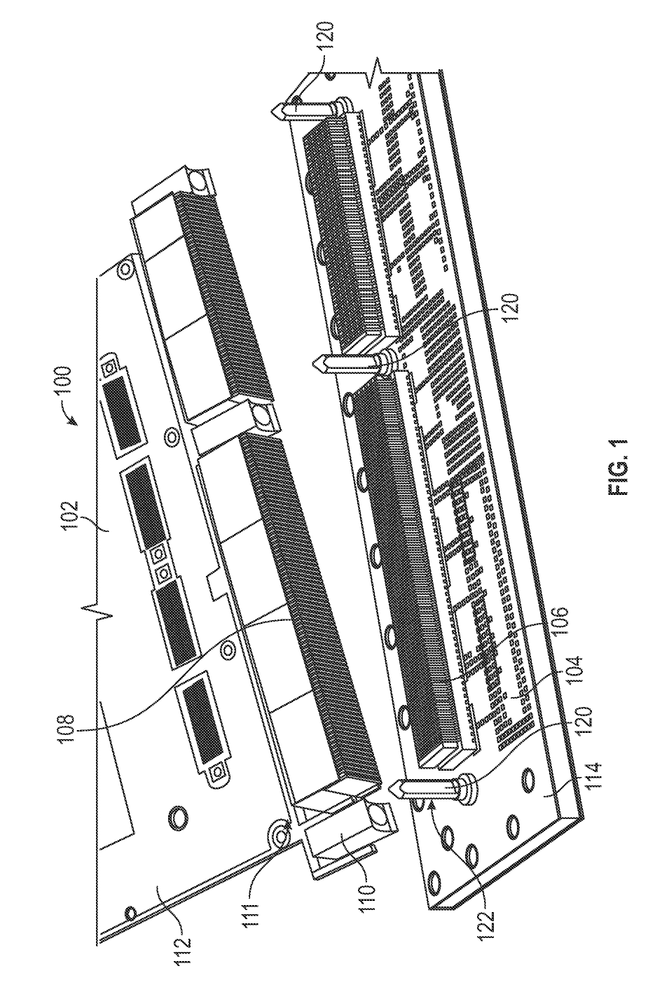

Illustrated in FIG. 1 is an example of an electronics board system 100. The electronics board system 100 can include one or more computer modules 102 and a backplane 104. The one or more computer modules 102 can include various modules or daughter cards, such as CPUs, memory modules, and input/output cards. The backplane 104 can include a circuit board that can be a central hub. The backplane 104 can be designed to connect multiple components, such as multiple computer modules 102. This can provide a common bus for data and power to flow between them.

The backplane 104 can support a plurality of interconnects 106. The plurality of interconnects 106 can be arranged in a substantially parallel alignment. In an example, the plurality of interconnects 106 are arranged on the backplane according to the purpose. The plurality of interconnects 106 can protrude or extend from a backplane surface 114 of the backplane 104.

One or more keyed guide pins 120 can extend from the backplane surface 114. Each of the one or more keyed guide pins 120 can be positioned relative to the backplane 104 adjacent to another of the one or more keyed guide pins 120. In another example, each of the one or more keyed guide pins 120 can be positioned proximate to at least one of the plurality of interconnects 106.

The one or more keyed guide pins 120 can have a keyed profile 122. The keyed profile 122 can be specific to one or more computer modules 102. For example, the one or more computer modules 102 can be locked out from connection with the backplane 104 in situations where the keyed profile 122 of the one or more keyed guide pins 120 does not correspond with a keyed aperture of the one or more computer modules 102 (as will be described later). For instance, the one or more computer modules 102 can be prohibited from engagement with the backplane 104 before interconnecting the one or more computer modules 102 with the backplane 104.

The one or more computer modules 102 includes, for example, a substrate 112 with a plurality of complementary interconnects 108. The plurality of complementary interconnects 108 can extend from an end portion 111 of the substrate 112. The plurality of complementary interconnects 108 are formed to be brought into engagement, and electrically connect, with corresponding plurality of interconnects 106 on the backplane 104.

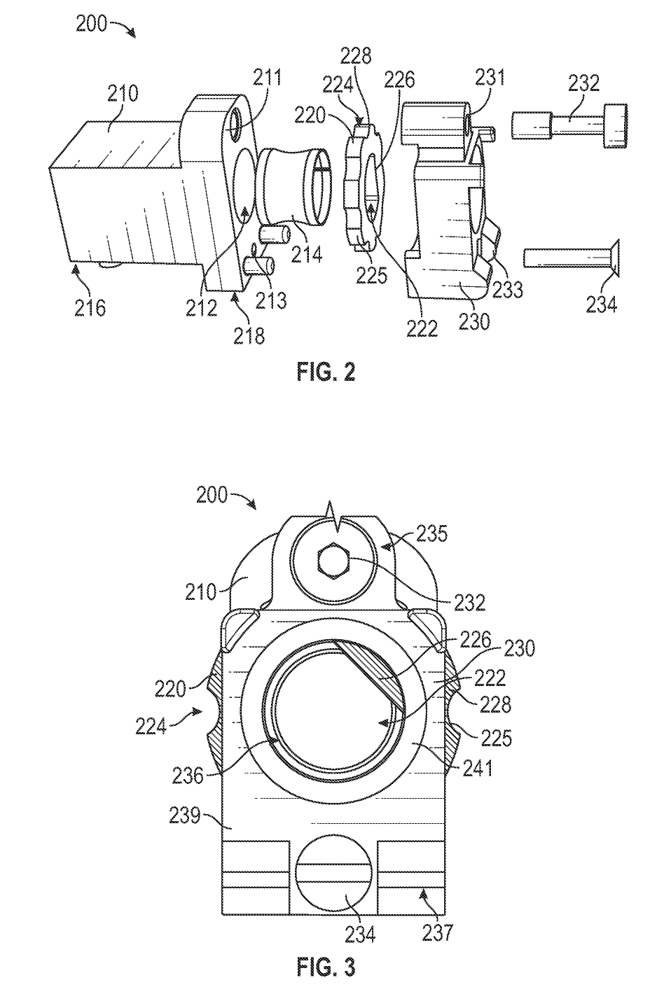

The one or more computer modules 102 includes one or more electrical guide connectors 110. The one or more electrical guide connectors 110 are oriented on the one or more computer modules 102 to engage with a corresponding one or more keyed guide pins 120. Each of the one or more electrical guide connectors 110 includes a keyed aperture (as described as related to FIG. 2) that corresponds with the keyed profile 122 of the one or more keyed guide pins 120.

Illustrated in FIG. 2 is an example of an exploded view of an adjustable electrical guide connector 200 (similar to the one or more electrical guide connectors 110 discussed related to FIG. 1). The adjustable electrical guide connector 200 is a body that can be designed and formed to receive one or more specific keyed guide pins (such as one or more keyed guide pins 120 discussed related to FIG. 1). The adjustable electrical guide connector 200 includes components that can be rotated, adjusted, articulated, pivoted, moved or the like, to accommodate different keyed guide pins.

For example, the adjustable electrical guide connector 200 includes a rotatable article 220. The rotatable article 220 can be a wheel, dial, switch, or the like. While the rotatable article 220 is illustrated as a wheel, other articles that can alternate between at least two positions is contemplated. In examples, the rotatable article 220 includes a keyed aperture 222. The keyed aperture 222 can at least partially extend within the rotatable article 220. The keyed aperture 222 can extend completely through the rotatable article 220.

The keyed aperture 222 can include one or more key angles 226 that can be reoriented to accommodate one or more keyed profiles of different keyed guide pins. The rotatable article 220 can be reoriented such that the one or more key angles 226 is repositioned to accommodate guide pins having different keyed profiles.

The adjustable electrical guide connector 200 can include a main body 210. The main body 210 can extend from a proximal portion 216 to a distal portion 218. The proximal portion 216 can be the portion of the main body 210 closest to, for example, the substrate 112 (discussed related to FIG. 1). The distal portion 218 is further from the substrate 112 than the proximal portion 216. The distal portion 218 includes a main body face 211.

A reception opening 212 can be defined within the main body face 211. The reception opening 212 can be opening formed the distal portion 218 of the main body 210. A channel, tunnel, recess or the like can proximally extend from the reception opening 212 into the main body 210. A ground contact 214 can be received within the main body 210, such as proximate to the reception opening 212. In another example, the ground contact 214 can be positioned within a channel, tunnel, recess or the like that extends proximally from the reception opening 212. The ground contact 214 can be a ground when a guide pin, such as a keyed guide pin, is inserted into the adjustable electrical guide connector 200.

The rotatable article 220 can be positioned between the main body face 211 and a secondary body 230. The secondary body 230 can be positioned distally of the main body face 211. The secondary body 230 can retain the rotatable article 220 proximate to the main body 210, such as the main body face 211. The secondary body 230 can rotatably retain the rotatable article 220. For example, the secondary body 230 can retain the rotatable article 220 so the rotatable article 220 can rotate, adjust, articulate, pivot, or otherwise move.

In an example, the secondary body 230 includes a first passage 231 and a second passage 233. The first passage 231 and second passage 233 can each be formed to receive a fastener. For example, the first passage 231 can receive an engagement fastener 232 and the second passage 233 can receive a retention fastener 234. In another example, the first passage 231 can receive the engagement fastener 232 and the second passage 233 can receive the retention fastener 234.

The retention fastener 234 can couple the secondary body 230 to the main body 210. The retention fastener 234 can pass through the second passage 233 and into a reception passage 213 of the main body 210. The retention fastener 234 can securely couple the secondary body 230 to the main body 210 so the secondary body 230 is substantially immovable relative to the main body 210.

The engagement fastener 232 can be selectively received within the secondary body 230. For example, the engagement fastener 232 can be translatably retained in the first passage 231. For example, the engagement fastener 232 can translate or reposition the engagement fastener 232 relative to the secondary body 230. The engagement fastener 232 can be translated to be received within a positioning recess 224. The positioning recess 224 can be formed within a periphery 228 of the rotatable article 220. The engagement fastener 232 can be translated to be withdrawn, or removed, from the positioning recess 224. The engagement fastener 232 can pass through the first passage 231 and at least partially into the positioning recess 224 to limit rotation of the keyed aperture 222.

The rotatable article 220 can have at least two positioning recesses 224 positioned along the periphery 228. In other examples, there can be a plurality of the positioning recesses 224 along the periphery 228. The positioning recess 224 can be defined by radial portions of an outer surface 225 of the rotatable article 220. The positioning recess 224 can correspond to an orientation of the keyed aperture 222. The positioning recess 224 can receive the engagement fastener 232 to retain the rotatable article 220 in a position corresponding to a desired or preferred position of the keyed aperture 222.

Illustrated in FIG. 3 is a front view of an example of the adjustable electrical guide connector 200, as illustrated and discussed related to FIG. 2. FIG. 3 illustrates the secondary body 230 in front of the rotatable article 220 and the main body 210. The engagement fastener 232 can be retained proximate to a first side portion 235 of the secondary body 230. Proximate to a second side portion 237 can be a second passage 233 (as illustrated and discussed related to FIG. 2) retaining the retention fastener 234.

An alignment opening 236 can be formed within the secondary body 230. For example, the alignment opening 236 can extend from a proximal secondary body face 239 towards the main body 210. In an example the alignment opening 236 can extend through the secondary body 230. The alignment opening 236 can be at least partially aligned with the reception opening 212 (as discussed related to FIG. 2). The alignment opening 236 can be at least partially aligned with the keyed aperture 222 (as discussed related to FIG. 2) of the rotatable article 220. The alignment opening 236 can include a chamfer 241. The chamfer 241 can be angled in a distal direction. The chamfer 241 can assist with proper alignment of the keyed guide pin (as discussed related to FIG. 1). For example, the chamfer 241 can assist in positioning the keyed guide pin properly relative to the keyed aperture 222.

The rotatable article 220 can be formed to be exposed. At least one of the periphery 228 or the outer surface 225 can be exposed from between the main body 210 and the secondary body 230. The rotatable article 220 can be formed to be exposed so a user, device, apparatus or the like can interact with the rotatable article 220. The rotatable article 220 can alter the position of the keyed aperture 222.

The rotatable article 220 can be rotated, adjusted, articulated, pivoted, moved or the like to orient the keyed aperture 222 with the main body 210 and the secondary body 230. The rotatable article 220 can be oriented to receive a guide pin, such as the keyed guide pin at least partially into the alignment opening 236 and the keyed aperture 222. The one or more keyed angles 226 of the rotatable article 220 (as discussed related to FIG. 2) can be visually confirmed though the alignment opening 236.

A user can rotate, adjust, articulate, pivot, move, or the like, the rotatable article 220 to orient the keyed aperture 222 between, for example, a first orientation and a second orientation. The orientation of the one or more key angles 226 can be rotated, adjusted, articulated, pivoted, moved or the like to change the orientation of the keyed aperture 222.

The keyed aperture 222 can be translated or repositioned to retain the rotatable article 220 in a position suitable for the purpose. For example, the engagement fastener 232 can be placed within the positioning recess 224. The engagement fastener 232 can be implemented to maintain a position of the rotatable article 220.

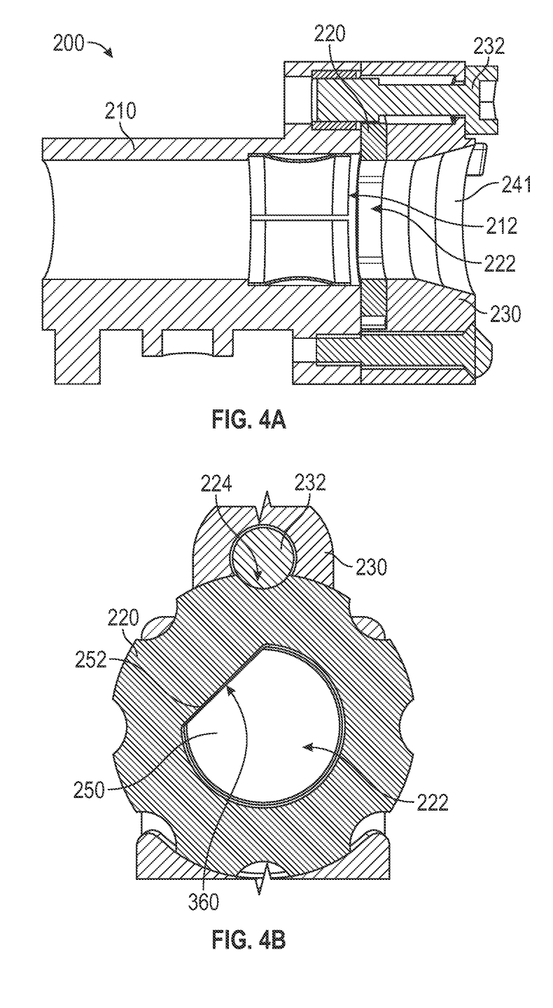

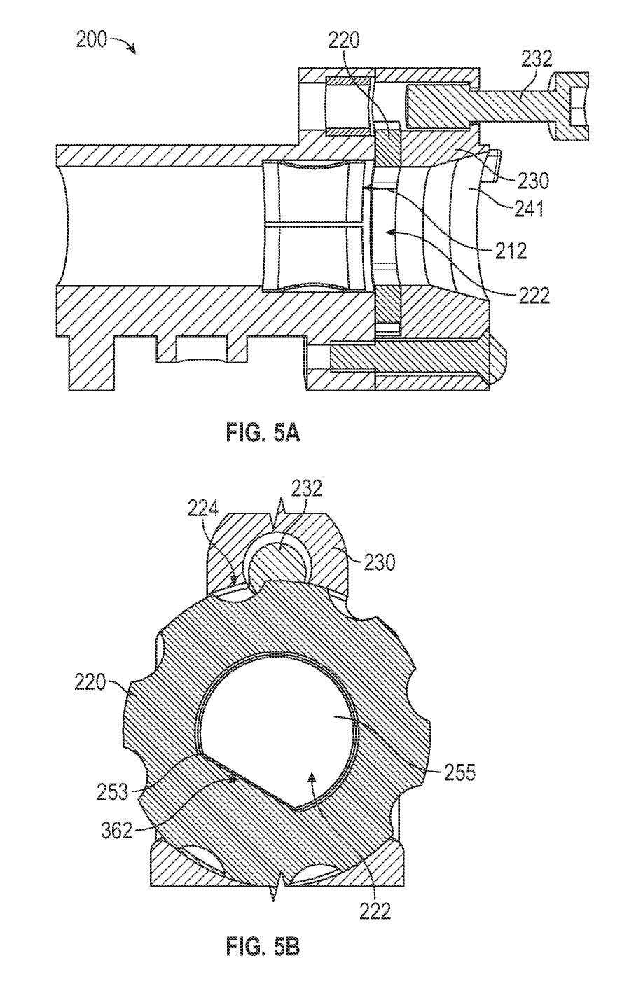

Illustrated in FIGS. 4A – 5B are examples of adjusting (e.g., changing, modifying, varying, or the like) the orientation of the keyed aperture 222. Illustrated in FIG. 4A and 5A are example cross sections of the adjustable electrical guide connector 200 (as illustrated and discussed related to FIG. 2 and FIG. 3). The engagement fastener 232 can be positioned in a retained configuration when positioned within the first passage 231. The engagement fastener 232 can extend through the first passage 231 and into the positioning recess 224 (as illustrated in FIGS. 4A and 4B). The engagement fastener 232 can maintain the orientation of the rotatable article 220 and the keyed aperture 222 so a keyed guide pin 250 can be at least partially within the keyed aperture 222.

The engagement fastener 232 can maintain the orientation of the rotatable article 220, for example, in a first orientation 360. In the first orientation 360, the one or more key angles 226 can be oriented to accommodate a first keyed guide pin 250. For example, the one or more key angles 226 can be complementary to a first keyed profile 252 of the first keyed guide pin 250.

In an example, the adjustable electrical guide connector 200 can be coupled with a computer module and can be transitioned to a second, different backplane. The computer module including the adjustable electrical guide connector 200 can be removed from a first backplane and can be positioned relative to the second, different, backplane. The second backplane can have a second keyed guide pin 255. The second keyed guide pin 255 can have a second one or more keyed angles 253. To accommodate the second keyed guide pin 255 having the second one or more keyed angles 253, the keyed aperture 222 can be oriented or repositioned to a second orientation 362.

As illustrated in FIGS. 5A and 5B, the engagement fastener 232 can be translated in a distal direction relative to the main body 210 and the secondary body 230. When the engagement fastener 232 is translated in a distal direction, the rotatable article 220 can be released from a retained, or locked, configuration. For instance, the engagement fastener 232 can be withdrawn from the positioning recess 224. The engagement fastener 232 can be positioned away from the rotatable article 220 to allow the rotatable article 220 to rotated, adjusted, articulated, pivoted, moved or the like.

When the engagement fastener 232 is translated away from the positioning recess 224 the rotatable article 220 can be rotated, adjusted, articulated, pivoted, moved or the like to orient the keyed aperture 222 to the second orientation 362. The second orientation 362 can be complementary to the second one or more keyed angles 253 of the second keyed guide pin 255. The second orientation 362 can be different than the first orientation 360. The second keyed guide pin 255 can be associated with the second backplane.

For example, the orientation of the keyed aperture 222 can be altered to accommodate one or more keyed guide pins (e.g., first keyed guide pin 250 or second keyed guide pin 255). The adjustable electrical guide connector 200 can be coupled with a computer module (as discussed related to FIG. 1). The computer module can be removed from a first backplane. Removing the computer module from the first backplane can include disconnecting the adjustable electrical guide connector 200 from the first keyed guide pin 250 on the first backplane. The computer module, including the adjustable electrical guide connector 200 can be reconfigured to accommodate the second keyed guide pin 255 on a second backplane.

In an example, the engagement fastener 232 can be translated in the distal direction to release the rotatable article 220 and allow the rotatable article 220 to rotate. Rotation of the rotatable article 220 can, for instance, convert (e.g., adjust, reorient, shift or the like) the keyed aperture 222 from the first orientation 360 to the second orientation 362. The engagement fastener 232 can be translated in the proximal direction. Translating the engagement fastener 232 in the proximal direction can position the engagement fastener 232 within the positioning recess 224. Positioning the engagement fastener 232 within the positioning recess 224 can retain the rotatable article 220 in the second orientation 362. In the second orientation 362 the second keyed guide pin 255, having a second key profile, can be received within the keyed aperture 222.

### ASPECTS

Aspect 1 can include subject matter such as an electrical guide connector comprising: a main body defining a reception opening; wherein the reception opening extends at least partially into the main body; a secondary body connectable with the main body, the secondary body including an alignment opening extending through the secondary body; wherein the alignment opening is at least partially aligned with the reception opening; a rotatable article positioned between the main body and the secondary body, the rotatable article including a keyed aperture at least partially aligned with the alignment opening and the reception opening; wherein the rotatable article is rotatable to orient the keyed aperture with respect to the main body and the secondary body to receive a guide pin at least partially into the alignment opening, and the keyed aperture when the guide pin is aligned with the keyed aperture.

Aspect 2 can include, or can optionally be combined with the subject matter of Aspect 1, to optionally include the main body includes a proximal portion and a distal portion, the distal portion including a main body face defining the reception opening.

Aspect 3 can include, or can optionally be combined with the subject matter of one or any combination of Aspects 1 or 2 to optionally include including an engagement fastener selectively couplable with the main body; wherein the rotatable article includes one or more positioning recesses defined by radial portions of an outer surface of the rotatable article; wherein the engagement fastener is configured to engage at least one of the one or more positioning recesses to limit rotation of the rotatable article.

Aspect 4 can include, or can optionally be combined with the subject matter of one or any combination of Aspects 1 to 3 to optionally include the rotatable article is configured to transition from a first keyed orientation to a second keyed orientation: in the first keyed orientation the keyed aperture is oriented in a first position; and in the second keyed orientation the keyed aperture is oriented in a second position different from the first position.

Aspect 5 can include, or can optionally be combined with the subject matter of one or any combination of Aspects 1 to 4 to optionally include an engagement fastener selectively couplable with the main body; the engagement fastener selectively couplable with the secondary body; wherein the rotatable article includes one or more positioning recesses defined by radial portions of an outer surface of the rotatable article; wherein the engagement fastener is configured to engage at least one of the one or more positioning recesses to limit rotation of the rotatable article; wherein the engagement fastener is translatable between an engaged position and a disengaged position: in the engaged position the engagement fastener is received within a positioning recess defined along the rotatable article; and in the disengaged position the engagement fastener is positioned away from the rotatable article.

Aspect 6 can include, or can optionally be combined with the subject matter of one or any combination of Aspects 1 to 5 to optionally include the guide pin is a keyed guide pin, the keyed aperture includes a corresponding keyed profile to the keyed guide pin.

Aspect 7 can include, or can optionally be combined with the subject matter of one or any combination of Aspects 1 to 6 to optionally include the electrical guide connector is coupled with a computer module.

Aspect 8 can include, or can optionally be combined with the subject matter of one or any combination of Aspects 1 to 6 to optionally include a high-speed electrical connection system comprising: a backplane including: a plurality of interconnects extending from a surface of the backplane; and at least one keyed guide pin extending from the surface of the backplane; a computer module including: a substrate including a plurality of complementary interconnects extending from the substrate, each of the plurality of complementary interconnects corresponding to at least one of the plurality of interconnects; and an electrical guide connector coupled to the substrate, the electrical guide connector including: a main body coupled to the substrate, the main body defining an opening; a rotatable article positioned in communication with the main body, the rotatable article including: a keyed aperture extending at least partially through the rotatable article, the keyed aperture complementarily formed to receive the at least one keyed guide pin at least partially therein; and one or more recesses positioned along a periphery of the rotatable article; a secondary body configured to retain the rotatable article between the main body and the secondary body; and at least one engagement fastener translatably retained within the secondary body, the at least one engagement fastener is selectively positioned within the one or more recesses.

Aspect 9 can include, or can optionally be combined with the subject matter of Aspect 8, to optionally include the secondary body is configured to rotatably retain the rotatable article relative to the main body.

Aspect 10 can include, or can optionally be combined with the subject matter of one or any combination of Aspects 8 or 9 to optionally include an engaged configuration and a disengaged configuration: in the engaged configuration, the at least one keyed guide pin extends through the secondary body, through the keyed aperture of the rotatable article, and the at least one engagement fastener is positioned within at least one of the one or more recesses; and in the disengaged configuration, the at least one engagement fastener is in a removed position relative to the one or more recesses, and the at least one keyed guide pin in a decoupled position relative to the rotatable article and the secondary body.

Aspect 11 can include, or can optionally be combined with the subject matter of one or any combination of Aspects 8 to 10 to optionally include the rotatable article is configured to have a first orientation and a second orientation: in the first orientation, a key feature of the keyed aperture is in a first position; and in the second orientation, the key feature of the keyed aperture is in a second, different position.

Aspect 12 can include, or can optionally be combined with the subject matter of one or any combination of Aspects 8 to 11 to optionally include the rotatable article is configured to rotate the keyed aperture from a first orientation to a second, different, orientation.

Aspect 13 can include, or can optionally be combined with the subject matter of one or any combination of Aspects 8 to 12 to optionally include a reception recess extending within the main body in a proximal direction from the opening; and a grounding contact positioned within the reception recess; wherein in an engaged configuration, the at least one keyed guide pin is positioned to extend through the secondary body, through the keyed aperture, and into the reception opening.

Aspect 14 can include, or can optionally be combined with the subject matter of one or any combination of Aspects 8 to 13 to optionally include a second backplane, the second backplane includes at least one second keyed guide pin, the at least one second keyed guide pin including a second key different than the at least one keyed guide pin; wherein the rotatable article is configured to rotate the keyed aperture from a first orientation corresponding to the at least one keyed guide pin to a second orientation corresponding to the at least one second keyed guide pin.

Aspect 15 can include, or can optionally be combined with the subject matter of one or any combination of Aspects 8 to 14 to optionally include a retention fastener that couples the secondary body with the main body.

Aspect 16 can include, or can optionally be combined with the subject matter of one or any combination of Aspects 8 to 15 to optionally include the secondary body defines an engagement recess; wherein the engagement recess is configured to receive the at least one engagement fastener; wherein the at least one engagement fastener is configured to extend through the engagement recess and into the one or more recesses.

Aspect 17 can include, or can optionally be combined with the subject matter of one or any combination of Aspects 8 to 16 to optionally include the high-speed electrical connection system is a component of a VPX board system.

Aspect 18 can include subject matter such as a method of adjusting an orientation of a keyed aperture of an electrical guide connector comprising: orienting the keyed aperture, defined by a rotatable article of an electrical guide connector, in a first orientation to correspond with a first keyed guide pin; wherein the electrical guide connector includes the rotatable article positioned between a main body and a secondary body; securing the rotatable article with an engagement fastener, the engagement fastener disposed within a recess of the rotatable article; translating the engagement fastener in a distal direction relative to the electrical guide connector; wherein translating the engagement fastener in the distal direction releases the rotatable article; rotating the rotatable article to orient the keyed aperture to a second orientation, the second orientation different from the first orientation; and securing the rotatable article with the engagement fastener, the engagement fastener disposed within the positioning recess of the rotatable article.

Aspect 19 can include, or can optionally be combined with the subject matter of Aspect 18, to optionally include accommodating one or more keyed guide pins, including: positioning the first keyed guide pin within the keyed aperture in the first orientation; inserting the first keyed guide pin in a recess defined by the secondary body and extending into the main body; removing the electrical guide connector from the first keyed guide pin; converting the keyed aperture from the first orientation to the second orientation by rotating the rotatable article; and inserting the second keyed guide pin into the keyed aperture in the second orientation.

Aspect 20 can include, or can optionally be combined with the subject matter of Aspects 18 or 19, to optionally include the electrical guide connector is coupled with a computer module, the method including: accommodating one or more keyed guide pins including: removing the computer module from a first backplane; converting the keyed aperture from the first orientation to the second orientation; and positioning the computer module on a second backplane including the second keyed guide pin.

The above description includes references to the accompanying drawings, which form a part of the detailed description. The drawings show, by way of illustration, specific embodiments in which the disclosed concepts can be practiced. These embodiments are also referred to herein as “aspects” or “examples.” Such aspects or example can include elements in addition to those shown or described. However, the description also contemplates aspects or examples in which only those elements shown or described are provided. Moreover, the description also contemplates aspects or examples using any combination or permutation of those elements shown or described (or one or more features thereof), either with respect to a particular aspects or examples (or one or more features thereof), or with respect to other Aspects (or one or more features thereof) shown or described herein.

In the event of inconsistent usages between this document and any documents so incorporated by reference, the usage in this document controls.

In this document, the terms “a” or “an” are used, as can be common in patent documents, to include one or more than one, independent of any other instances or usages of “at least one” or “one or more.” In this document, the term “or” can be used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel,” “perpendicular,” “round,” or “square,” are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that can be slightly oblong or can be a many-sided polygon) is still encompassed by this description.

The above description is intended to be illustrative, and not restrictive. For example, the above-described aspects or examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, subject matter may lie in less than all features of a particular disclosed embodiment. Thus, the following claims are hereby incorporated into the Detailed Description as aspects, examples, or embodiments, with each claim standing on its own as a separate embodiment, and it can be contemplated that such embodiments can be combined with each other in various combinations or permutations. The scope of the disclosed concepts should be determined with reference to the appended claims, along with the full scope of equivalents to which such claims are entitled.

1. An electrical guide connector comprising:
a main body defining a reception opening;
wherein the reception opening extends at least partially into the main body;
a secondary body connectable with the main body, the secondary body including an alignment opening extending through the secondary body;
wherein the alignment opening is at least partially aligned with the reception opening;
a rotatable article positioned between the main body and the secondary body, the rotatable article including a keyed aperture at least partially aligned with the alignment opening and the reception opening;
wherein the rotatable article is rotatable to orient the keyed aperture with respect to the main body and the secondary body to receive a guide pin at least partially into the alignment opening, and the keyed aperture when the guide pin is aligned with the keyed aperture.

2. The electrical guide connector of claim 1, wherein the main body includes a proximal portion and a distal portion, the distal portion including a main body face defining the reception opening.

3. The electrical guide connector of claim 1, including an engagement fastener selectively couplable with the main body;
wherein the rotatable article includes one or more positioning recesses defined by radial portions of an outer surface of the rotatable article;
wherein the engagement fastener is configured to engage at least one of the one or more positioning recesses to limit rotation of the rotatable article.

4. The electrical guide connector of claim 1, wherein the rotatable article is configured to transition from a first keyed orientation to a second keyed orientation:
in the first keyed orientation the keyed aperture is oriented in a first position; and
in the second keyed orientation the keyed aperture is oriented in a second position different from the first position.

5. The electrical guide connector of claim 1, including an engagement fastener selectively couplable with the main body;
the engagement fastener selectively couplable with the secondary body;
wherein the rotatable article includes one or more positioning recesses defined by radial portions of an outer surface of the rotatable article;
wherein the engagement fastener is configured to engage at least one of the one or more positioning recesses to limit rotation of the rotatable article;
wherein the engagement fastener is translatable between an engaged position and a disengaged position:
in the engaged position the engagement fastener is received within a positioning recess defined along the rotatable article; and
in the disengaged position the engagement fastener is positioned away from the rotatable article.

6. The electrical guide connector of claim 1, wherein the guide pin is a keyed guide pin, the keyed aperture includes a corresponding keyed profile to the keyed guide pin.

7. The electrical guide connector of claim 1, wherein the electrical guide connector is coupled with a computer module.

8. A high-speed electrical connection system comprising:
a backplane including:
a plurality of interconnects extending from a surface of the backplane; and
at least one keyed guide pin extending from the surface of the backplane;
a computer module including:
a substrate including a plurality of complementary interconnects extending from the substrate, each of the plurality of complementary interconnects corresponding to at least one of the plurality of interconnects; and
an electrical guide connector coupled to the substrate, the electrical guide connector including:
a main body coupled to the substrate, the main body defining an opening;
a rotatable article positioned in communication with the main body, the rotatable article including:
a keyed aperture extending at least partially through the rotatable article, the keyed aperture complementarily formed to receive the at least one keyed guide pin at least partially therein; and
one or more recesses positioned along a periphery of the rotatable article;
a secondary body configured to retain the rotatable article between the main body and the secondary body; and
at least one engagement fastener translatably retained within the secondary body, the at least one engagement fastener is selectively positioned within the one or more recesses.

9. The high-speed electrical connection system of claim 8, wherein the secondary body is configured to rotatably retain the rotatable article relative to the main body.

10. The high-speed electrical connection system of claim 8, including an engaged configuration and a disengaged configuration:
in the engaged configuration, the at least one keyed guide pin extends through the secondary body, through the keyed aperture of the rotatable article, and the at least one engagement fastener is positioned within at least one of the one or more recesses; and
in the disengaged configuration, the at least one engagement fastener is in a removed position relative to the one or more recesses, and the at least one keyed guide pin in a decoupled position relative to the rotatable article and the secondary body.

11. The high-speed electrical connection system of claim 8, wherein the rotatable article is configured to have a first orientation and a second orientation:
in the first orientation, a key feature of the keyed aperture is in a first position; and
in the second orientation, the key feature of the keyed aperture is in a second, different position.

12. The high-speed electrical connection system of claim 8, wherein the rotatable article is configured to rotate the keyed aperture from a first orientation to a second, different, orientation.

13. The high-speed electrical connection system of claim 8, including:
a reception recess extending within the main body in a proximal direction from the opening; and
a grounding contact positioned within the reception recess;
wherein in an engaged configuration, the at least one keyed guide pin is positioned to extend through the secondary body, through the keyed aperture, and into the reception opening.

14. The high-speed electrical connection system of claim 8, including a second backplane, the second backplane includes at least one second keyed guide pin, the at least one second keyed guide pin including a second key different than the at least one keyed guide pin;
wherein the rotatable article is configured to rotate the keyed aperture from a first orientation corresponding to the at least one keyed guide pin to a second orientation corresponding to the at least one second keyed guide pin.

15. The high-speed electrical connection system of claim 8, including a retention fastener that couples the secondary body with the main body.

16. The high-speed electrical connection system of claim 8, wherein the secondary body defines an engagement recess;
wherein the engagement recess is configured to receive the at least one engagement fastener;
wherein the at least one engagement fastener is configured to extend through the engagement recess and into the one or more recesses.

17. The high-speed electrical connection system of claim 8, wherein the high-speed electrical connection system is a component of a VPX board system.

18. A method of adjusting an orientation of a keyed aperture of an electrical guide connector comprising:
orienting the keyed aperture, defined by a rotatable article of an electrical guide connector, in a first orientation to correspond with a first keyed guide pin;
wherein the electrical guide connector includes the rotatable article positioned between a main body and a secondary body;
securing the rotatable article with an engagement fastener, the engagement fastener disposed within a recess of the rotatable article;
translating the engagement fastener in a distal direction relative to the electrical guide connector;
wherein translating the engagement fastener in the distal direction releases the rotatable article;
rotating the rotatable article to orient the keyed aperture to a second orientation, the second orientation different from the first orientation; and
securing the rotatable article with the engagement fastener, the engagement fastener disposed within the positioning recess of the rotatable article.

19. The method of altering the orientation of the keyed aperture of the electrical guide connector of claim 18, including:
accommodating one or more keyed guide pins, including:
positioning the first keyed guide pin within the keyed aperture in the first orientation;
inserting the first keyed guide pin in a recess defined by the secondary body and extending into the main body;
removing the electrical guide connector from the first keyed guide pin;
converting the keyed aperture from the first orientation to the second orientation by rotating the rotatable article; and
inserting the second keyed guide pin into the keyed aperture in the second orientation.

20. The method altering the orientation of the keyed aperture of the electrical guide connector of claim 18, wherein the electrical guide connector is coupled with a computer module, the method including:
accommodating one or more keyed guide pins including:
removing the computer module from a first backplane;
converting the keyed aperture from the first orientation to the second orientation; and
positioning the computer module on a second backplane including the second keyed guide pin.
